(19) United States
(12) Patent Application Publication
(10) Pub. No.: US 2019/0234140 A1
(43) Pub. Date: Aug. 1, 2019

(54) Operating Device for a Pleated Blind

(71) Applicant: Vako B.V., `s-Hertogenbosch (NL)

(72) Inventor: Nanne Willem VALKENBURG, Vugt (NL)

(21) Appl. No.: 16/263,234

(22) Filed: Jan. 31, 2019

(30) Foreign Application Priority Data
Feb. 1, 2018 (NL) 2020367

(51) Int. Cl. E06B 9/322; E06B 9/262

(52) U.S. Cl. CPC E06B 9/322; E06B 2009/2627; E06B 9/262

(57) ABSTRACT

The invention relates to an operating device for a pleated blind, comprising at least two cord spools lying parallel to each other and being axially rotatable for winding up and unwinding cords connected with a lower beam and an upper beam of the pleated blind, and at least two drive shafts that connect each of the cord spools with separate operating elements. At least one of the drive shafts hereby comprises mutually cooperating shaft parts, wherein at least two shaft parts are mutually oriented substantially parallel and at least partially adjacent to each other, and wherein at least one shaft part cooperates with an operating element, and at least one other shaft part cooperates with at least one cord spool. The invention also relates to an assembly of a pleated blind and such an operating device.

The invention relates to an operating device for a pleated blind, but can also be used in other types of window coverings, such as roller blinds, venetian blinds and other rollable or foldable window coverings. The invention also relates to an assembly of a pleated blind and such an operating device.

It is generally known to let rollable or foldable window coverings cover a window to a greater or lesser extent by adjusting the height of the window covering at the bottom side. It is also often possible to adjust the top side of the window covering in height in order to obtain a certain degree of light incidence without compromising privacy. The mechanism which allows for this adjustability usually utilizes several cords connected to the window covering, which can be rolled up at least partly on a cord spool intended for this purpose. The number of cords engaging the window covering will hereby increase with respect to singular adjustable window covers if the window covering can be adjusted in several ways. The number of cord spools for wrapping around these cords also increases.

In order to prevent the cords from becoming entangled, which is in particular a risk with adjusting mechanisms for multi-adjustable window coverings, the cords are guided by way of guides such as pulleys from the cord spools towards the point of application on the window covering. Because of the contact with the cords, these guides causes the friction experienced by the cords when the cords are displaced to increase. In addition, the complexity of the operation increases as the number of cord spools to be operated increases.

The aforementioned matters cause an increase in the adjustment possibilities of the window covering in particular to be at the expense of a smooth operating experience of the window covering. The object of the present invention is therefore to provide an improved way of adjusting window coverings, and in particular rollable or foldable window coverings, wherein the above problems are at least partially addressed.

To this end the invention provides an operating device for a pleated blind, comprising: at least one first axially rotatable cord spool, which at least one first cord spool is configured for winding up and unwinding a first cord connected to a lower beam of the pleated blind; at least one first drive shaft connected to the at least one first cord spool; and at least one first operating element connected to the drive shaft for axially rotating the first cord spool; at least one second axially rotatable cord spool, which at least one second cord spool is configured for winding up and unwinding a second cord connected to an upper beam of the pleated blind; at least one second drive shaft connected to the at least one second cord spool; and at least one second operating element connected to the second drive shaft for axially rotating the second cord spool, wherein a first longitudinal axis of the at least one first cord spool lies substantially parallel to a second longitudinal axis of the at least second cord spool, and wherein at least one drive shaft of the first drive shaft and the second drive shaft comprises a plurality of mutually cooperating shaft parts, wherein at least two shaft parts are mutually oriented substantially parallel and at least partially adjacent to each other, and wherein at least one shaft part cooperates with an operating element, and at least one other shaft part cooperates with at least one cord spool.

The cord spools suitable for the operating device are preferably substantially cylindrical or substantially cylinder-shaped, the axial axis of rotation of which coincides with the longitudinal axis of the cord spool. Upon rotation about this longitudinal axis, the cord connected to the cord spool will wrap around or unwind from the cord spool. Each cord spool is coupled to a drive shaft, of which a part coupled to the cord spool coincides in an ordinary case with the axis of rotation/longitudinal axis of the cord spool. The drive shaft has the function of coupling the cord spool with an operating element, whereby the cord spool can be rotated by means of the operating element. The operating element hereby usually engages a part of the drive shaft opposite the part of the drive shaft which is coupled to the cord spool. The at least one drive shaft comprising several mutual shaft parts thereby makes it possible to position these opposite parts out of one line, which is effected by aligning the shaft parts side by side and substantially parallel to each other. This provides a flexibility in the positioning of the cord spools and the operating elements, whereby the cord spools and operating elements can be placed independently of each other at the most favourable location in the operating device. For example, it becomes possible for the cord spools to be placed above the window covering in such a way that the cords run straight down from the cord spools. This is advantageous as, because of this, no additional guidance from the cord spools, and therefore contact with the cord spools, is required, as a result of which the friction experienced during displacement of the cords is minimal, which results in a smooth and light operation. The cord spools must for this purpose be placed decentralized in the operating device as seen from a top view. However, it is often desirable for the operating elements, when likewise seen from a top view, to be centrally accommodated in the operating device. In this way, the dimensions of the operating elements can be chosen to be as large as is possible in view of the dimensions of the operating device, which generally benefits the strength and reliability of the operating elements. Another advantage of the present operating device is obtained by assigning separate operating elements to the first and the second cord spools for the operation thereof. Practice shows that assigning a separate operating element to each of the adjustment freedoms of a multiple adjustable window covering (in this case adjusting both the upper beam and the lower beam is possible) leads to an easy and intuitive operation. The first operating element and/or the second operating element may be manually operated. However, it is also conceivable for the first operating element and/or the second operating element to be driven electromechanically by means of a first electric motor or a second electric motor, respectively. If an electric motor is used, it is conceivable that the electric motor is controlled by means of a wired and/or wireless (electronic) control.

Depending on the specific requirements imposed on the operation and shape of a pleated blind, a) the first drive shaft may comprise a plurality of mutually cooperating shaft parts, wherein at least two shaft parts are mutually oriented substantially parallel and at least partially adjacent to each other, and wherein at least one shaft part cooperates with the first operating element, and at least one other shaft part cooperates with at least one first cord spool, and/or b) the second drive shaft may comprise a plurality of mutually cooperating shaft parts, wherein at least two shaft parts are mutually oriented substantially parallel and at least partially adjacent to each other, and wherein at least one shaft part co-operates with the second operating element, and at least one other shaft part cooperates with at least one second cord spool.

In a possible embodiment of the operating device according to the invention, the mutually cooperating shaft parts cooperate mutually by means of a mechanical transmission, in particular a gear transmission. In a conventional case this gear transmission is designed such that each of the mutually cooperating shaft parts comprises a gear wheel, wherein gear wheels of adjacent shaft parts are arranged for mutual cooperation. Alternatively, the mutually interacting shaft parts can also be in physical contact with each other. In a possible embodiment of the mechanical transmission, the transmission provides a 1:1 transmission ratio between the first and second parts of the drive shafts, whereby the part of a drive shaft connected to the operating element rotates through the same angle as a part of the same drive shaft connected to the cord spool. This is usually beneficial for intuitive operation.

For the first and second cord spools it is advantageous if they are not only arranged parallel to each other with their longitudinal axes, but that they are, as seen from a front view, situated behind each other, in particular in a straight line. This is because the height of the operating device, defined as the length of the operating device in a direction perpendicular to the longitudinal axes of the cord spools, can hereby be limited to substantially the diameter of the cord spools. In addition, this arrangement enables the cords connected to the first and second cord spools which are located behind one another, to lie immediately behind each other as seen from a front view. As a result, with a conventional view on the front or rear side of the window covering the number of visible cords decreases, which is desirable from an aesthetic point of view.

In a possible embodiment of the operating device according to the invention, the first operating element comprises a first wheel, in particular a first sprocket, and the second operating element comprises a second wheel, in particular a second sprocket. These wheels can be rotated by the user, for instance by means of cords guided over these wheels or, in the case of sprockets, chains. In general, each wheel, in particular each sprocket, is provided on a circumferential side with a circumferential groove for accommodating a part of a chain or cord, so that the chain or cord can stably cooperate with the relevant wheel, in particular sprocket wheel. Displacement of the chain or the cord hereby results in rotation of the relevant wheel, in particular a sprocket. Incidentally, the movement of the chain or the cord will usually be done manually, but it is also conceivable for the chain and/or the cord to be driven in an electromechanical manner.

The wheels hereby engage, optionally with the intervention of a transmission (provided in the operating element), on one of the first and second drive shafts, thus enabling direct operation of the drive shaft and the cord spool connected thereto. However, it is also conceivable that the operating device comprises other operating elements with the same purpose of rotating one of the drive shafts. In a given case, a first axis of rotation of the first wheel coincides with a second axis of rotation of the second wheel, so that the wheels of the operating elements are mutually aligned.

By having at least one drive shaft of the first drive shaft and the second drive shaft comprise a plurality of mutually cooperating shaft parts which are arranged next to each other and are thus situated out of line from each other, it is possible for a first axis of rotation of the first wheel to be out of alignment with the first longitudinal axis of the at least one first cord spool, or for a second axis of rotation of the second wheel to be out of alignment with the second longitudinal axis of the at least one second cord spool. As already mentioned before, this makes it possible, on the one hand, that the operating elements are placed centrally in the operating device as seen from a top view, while the cord spools, also viewed from a top view, are placed decentrally in the operating device, which makes it possible for the cords to run straight down from the cord spools.

In a further embodiment of the operating device according to the invention, the operating device comprises a plurality of first cord spools, wherein first longitudinal axes of the cord spools mutually coincide. It is also possible that the operating device comprises a plurality of second cord spools, wherein the second longitudinal axes of the cord spools mutually coincide. By using several spool pairs in the operating device, the window covering can be supported on several sides (in a usual case the upper and lower side) at several spaced apart points. As a result, not only a more stable suspension is obtained, but it is also possible to adjust the window covering in a controlled manner in multiple ways. In a specific case, the operating device comprises at least two first cord spools and at least two second cord spools, wherein the first cord spools and second cord spools are mutually arranged behind each other in the longitudinal direction of the cord spools such that the axes of rotation of the first cord spools and second cord spools lie mutually in line. The different first cord spools or different second cord spools are usually placed at the ends of the operating device, so that the lower beam and/or upper beam of the window covering is supported over substantially its full width.

In the above-described case wherein the operating device comprises a plurality of first cord spools or second cord spools, the first cord spools may be connected to the same shaft part of the first drive shaft and/or the second cord spools may be connected to the same shaft part of the second drive shaft. This shaft part of the first drive shaft/second drive shaft hereby forms a connecting shaft which transmits the rotation of a first one of the first/second cord spools onto a second one of the first/second cord spools. This makes it possible to rotate several cord spools synchronously by means of a single operating element, so that a part of a window covering suspended from these cord spools can be displaced in a level and controlled manner.

In order to prevent the cords of the adjacent cord spools from coming into contact with each other and becoming entangled, the cord spools may be separated from each other by means of a separating element. A suitable separating element extends substantially completely between the cord spools. The control device may also comprise at least one stabilizing element connected to a first cord spool and a second cord spool for securing the mutual positioning of the first cord spool and the second cord spool. In particular, at least one stabilizing element may be coupled to a head end of the first cord spool and a head end of the second cord spool, wherein the stabilizing element is provided with at least one passage opening for passage of the first drive shaft and/or the second drive shaft.

The operating device usually comprises an elongated support structure in which the cord spools and at least a part of the drive shafts are accommodated. This elongated support structure serves to shield and fasten the moving parts of the operating device and may in a typical instance additionally be configured for attachment to the fixed world, such as a frame or ceiling. The separating element discussed above and the stabilizing elements also discussed above may, if used, in a usual case be connected to the support structure.

The first operating element and the second operating element are preferably placed on opposite end faces of the elongated support structure. This is advantageous in view of both the available space on the operating device and the ease with which the different operating elements can be kept apart. In particular, it is advantageous if the first and second operating elements are placed centrally at the end faces of the elongated support structure. A central installation is often the most space-saving and also offers the most space for the operating element, so that it can accommodatingly be dimensioned in view of the robustness of the construction.

The invention also relates to an assembly of a pleated blind and an operating device according to one of the above-described embodiments, wherein the at least one first cord spool is connected by means of at least one first cord to a lower beam of the pleated blind, and wherein the at least one second cord spool is connected by means of at least one second cord to an upper beam of the pleated blind. It is also possible that the operating device according to the invention forms an assembly with another window covering, and in particular a rollable or foldable window covering such as roller blinds, roman blinds or venetian blinds. The advantages of such an assembly have already been extensively discussed in the foregoing with respect to the operating device. In an advantageous embodiment of the assembly according to the invention, the cord spools are placed directly above the pleated blind, such that the cords run straight down from the cord spools. As a result, no additional guiding of the cord spools, and hence contact with the cord spools, is required, as a result of which the friction experienced during displacement of the cords is minimal, which leads to a smooth and light operation of the window covering.

The invention will now be elucidated on the basis of non-limitative exemplary embodiments shown in the following figures. Herein:

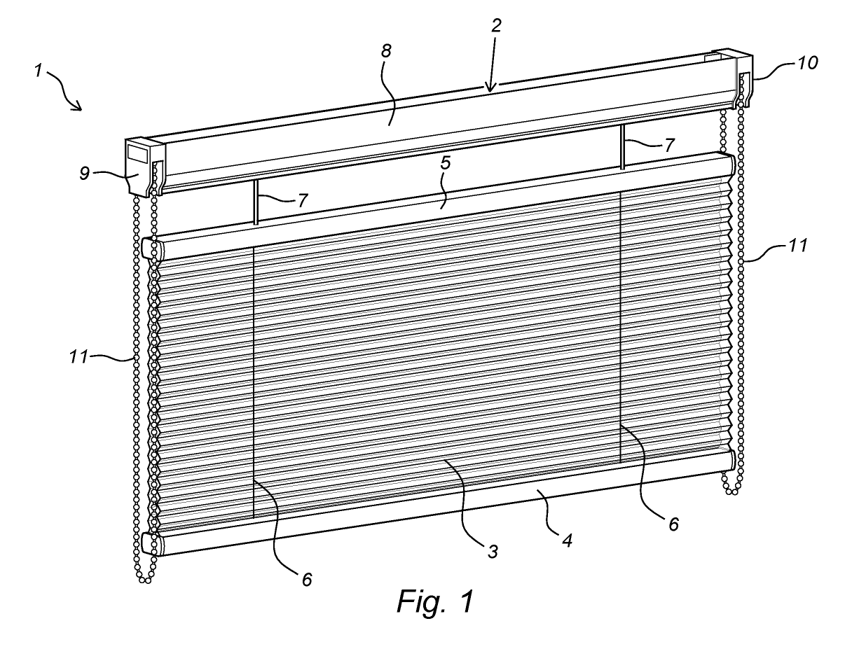

FIG. 1 shows a perspective view of a window covering provided with an operating device according to the invention,

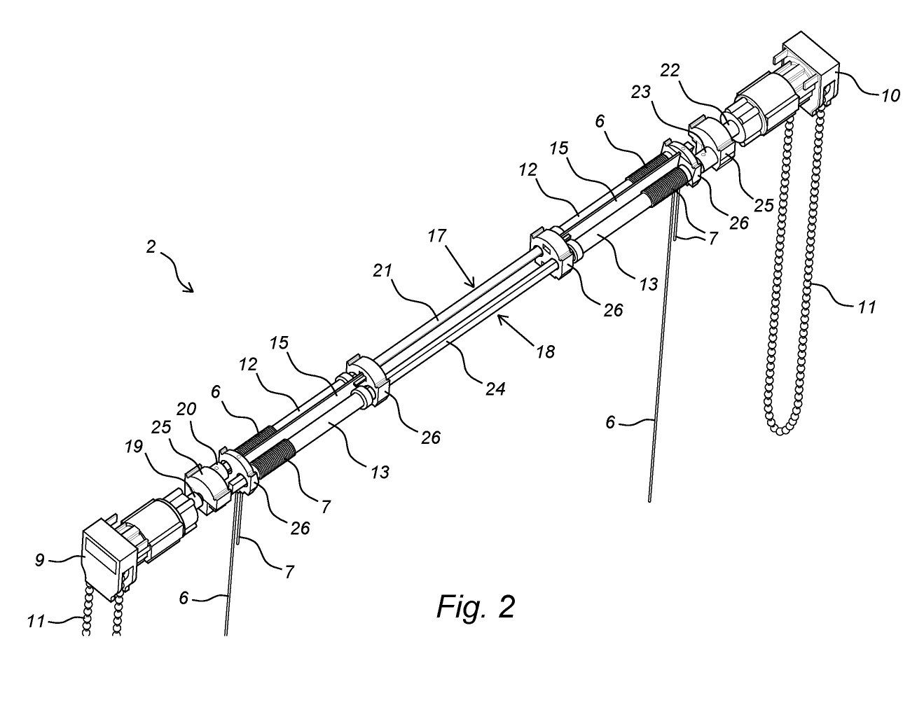

FIG. 2 shows a different perspective view of the operating device as shown in FIG. 1, and

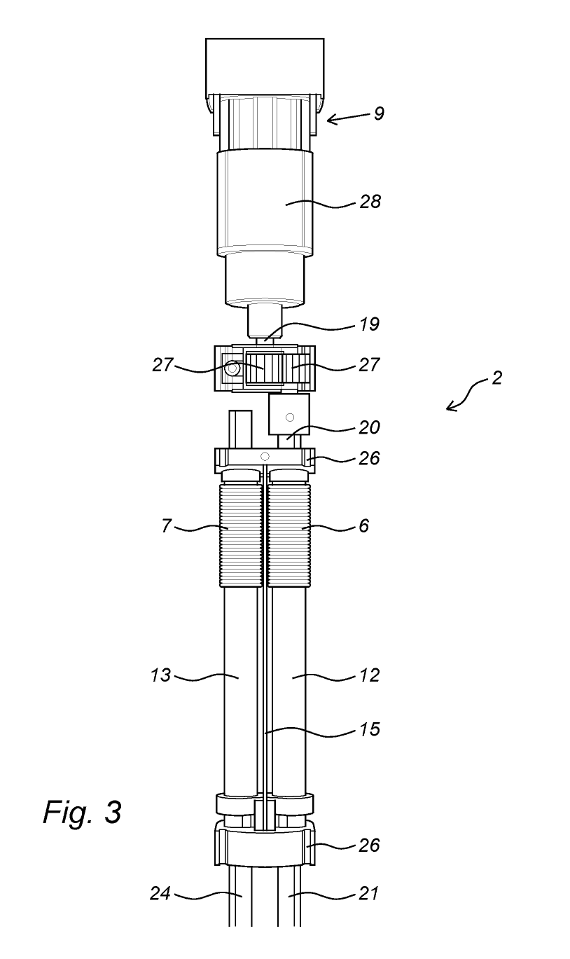

FIG. 3 shows a plan view of a detail of the operating device as shown in FIGS. 1 and 2.

FIG. 1 shows a perspective view of a window covering 1 provided with an operating device 2 according to the invention. In the present case, the window covering 1 is formed by a pleating blind 3 which extends between a lower beam 4 and an upper beam 5, the lower beam 4 and the upper beam 5 bounding the curtain on a lower side and an upper side, respectively. The lower beam 4 and upper beam 5 are suspended from the operating device 2 by means of two first cords 6 respectively two second cords 7. For the stability of the suspension, the cords 6, 7 herein engage the lower beam 4 respectively the upper beam 5 at two spaced-apart locations. The operating device 2 comprises an elongated support structure 8 in which—as will appear from the following figures—the cord spools and the drive shafts of the operating device 2 are included. A first and a second operating element 9, 10 are placed centrally at the end faces of the support structure 8 for operating the lower beam 4 respectively the upper beam 5. The operating elements 9, 10 shown comprise a sprocket driven by means of a chain 11, with which the cords 6, 7 engaging the lower beam 4 and the upper beam 5 can be rolled up or unwound. The elongated support structure 8 may thereby be arranged for attachment to the fixed world, to which end the support structure 8 may be provided with a mounting structure intended for this purpose.

FIG. 2 shows another perspective view of the operating device 2 as shown in FIG. 1. The shown variant of the operating device 2 comprises a pair of first cord spools 12 and a pair of second cord spools 13 which are arranged one behind the other in a longitudinal direction 14 of the operating device 2. The cord spools 12, 13 are each at least partially wrapped by one of the cords 6, 7 from which the pleated blind is suspended. The cords 6, 7 are unwound or wound up rotating the cord spools 12, 13 around their longitudinal axes. In order to prevent possible entanglement of the cords 6, 7, the cord spools 12, 13 are separated from one another by means of separating elements 15. The first and second cord spools 12, 13 are connected to a first drive shaft 17 and a second drive shaft 18, respectively. The first drive shaft 17 comprises a plurality of mutually cooperating shaft parts 19, 20, 21 and the second drive shaft 18 comprises a plurality of mutually cooperating shaft parts 22, 23, 24, wherein the shaft parts 19, 20, 21, 22, 23, 24 are mutually oriented substantially parallel and at least partially adjacent to each other, and wherein for both the first drive shaft 17 and the second drive shaft 18 at least one shaft part 19, 22 cooperates with an operating element 9, 10, and at least one other shaft part 20, 23 cooperates with a cord spool 12, 13. Finally, the same shaft part 21 of the first drive shaft and the same shaft part 24 of the second drive shaft connect the first cord spools 12 and the second cord spools 13, respectively. The first cord spools 12 and second cord spools 13 are, as seen from a front view, further arranged in a straight line wherein the longitudinal axes of the cord spools 12, 13 extend parallel to each other. Coupling of the mutually cooperating shaft parts 19, 20, 22, 23 associated with the first drive shaft or the second drive shaft is effected by transmissions 25 through which a rotation of one of the cooperating shaft parts 19, 22 belonging to one of the drive shafts 17, 18 is transferred onto another one of the cooperating shaft parts 20, 23 belonging to one of the drive shafts 17, 18. The rotational relationship between these mutually cooperating shaft parts 19, 20, 22, 23 may be chosen by selecting a transmission 25 with a specific transmission ratio. Furthermore, the operating device 2 is provided with a plurality of stabilizing elements 26, each of which is coupled to a head end of the first cord spool 12 and a head end of the second cord spool 13. Each stabilizing element 26 is hereby provided with passage openings for the passage of the first drive shaft 17 and the second drive shaft 18.

FIG. 3 shows a plan view of a detail of the operating device 2 as shown in FIGS. 1 and 2, wherein identical elements are designated with identical reference numerals. As can clearly be seen in FIG. 3, the transmission 25 between the mutually cooperating shaft parts 19, 20 of the first drive shaft 17 comprises two gear wheels 27 engaging each other. In the configuration shown both gear wheels 27 have the same size, which results in a 1:1 transmission ratio. However, it is also conceivable to select a different transmission ratio on the basis of the desired ratio between displacement of the operating element 9 and the rotation of the cord spool(s) 12 connected thereto. The operating element 9 shown comprises a sprocket (not shown) driven by a chain 11, which sprocket is via a further transmission provided in a transmission housing 28 coupled to one shaft part 19 of the mutually cooperating shaft parts 19, 20, 21 of the first drive shaft 17. The latter further transmission may hereby also influence the transmission ratio.

It should be clear that the invention is not limited to the exemplary embodiments shown and described here, but that within the scope of the appended claims, many variants are possible which will be obvious to the person skilled in the art. It is hereby conceivable that various inventive concepts and/or technical features of the embodiments described above can be combined in whole or in part without departing from the inventive concept described in the appended claims.

The verb ‘comprising’ and its conjugations included in this patent are not only understood to mean ‘comprising’, but are also to be understood as the expressions ‘contain’, ‘essentially consist, ‘formed by’, and conjugations thereof.

What is claimed is:

1. Operating device for a pleated blind, comprising:
at least one first axially rotatable cord spool, which at least one first cord spool is configured for winding up and unwinding a first cord connected to a lower beam of the pleated blind,
at least one first drive shaft connected to the at least one first cord spool,
at least one first operating element connected to the drive shaft for axially rotating the first cord spool,
at least one second axially rotatable cord spool, which at least one second cord spool is configured for winding up and unwinding a second cord connected to an upper beam of the pleated blind,
at least one second drive shaft connected to the at least one second cord spool, and
at least one second operating element connected to the second drive shaft for axially rotating the second cord spool,
wherein a first longitudinal axis of the at least one first cord spool lies substantially parallel to a second longitudinal axis of the at least second cord spool, and wherein at least one drive shaft of the first drive shaft and the second drive shaft comprises a plurality of mutually cooperating shaft parts, wherein at least two shaft parts are mutually oriented substantially parallel and at least partially adjacent to each other, and wherein at least one shaft part cooperates with an operating element, and at least one other shaft part cooperates with at least one cord spool.

2. Operating device according to claim 1, wherein the first drive shaft comprises a plurality of mutually cooperating shaft parts, wherein at least two shaft parts are mutually oriented substantially parallel and at least partially adjacent to each other, and wherein at least one shaft part cooperates with the first operating element, and at least one other shaft part cooperates with at least one first cord spool.

3. Operating device according to claim 1 or 2, wherein the second drive shaft comprises a plurality of mutually cooperating shaft parts, wherein at least two shaft parts are mutually oriented substantially parallel and at least partially adjacent to each other, and wherein at least one shaft part co-operates with the second operating element, and at least one other shaft part cooperates with at least one second cord spool.

4. Operating device according to claim 1, wherein mutually cooperating shaft parts mutually cooperate by means of a mechanical transmission, in particular a gear transmission.

5. Operating device according to claim 4, wherein the mechanical transmission has a 1:1 gear ratio.

6. Operating device according to claim 1, wherein each of the mutually cooperating shaft parts comprises a gear wheel, wherein gear wheels of adjacent shaft parts are configured for mutual cooperation.

7. Operating device according to claim 1, wherein mutually interacting shaft parts are in physical contact with each other.

8. Operating device according to claim 1, wherein the first cord spool and the second cord spool, as seen from a front view, are situated behind each other, in particular in a straight line.

9. Operating device according to claim 1, wherein the first operating element comprising a first wheel, in particular a first sprocket, and wherein the second operating element comprises a second wheel, in particular a second sprocket.

10. Operating device according to claim 9, wherein a first axis of rotation of the first wheel coincides with a second axis of rotation of the second wheel.

11. Operating device according to claim 9, wherein a first axis of rotation of the first wheel is located out of line of the first longitudinal axis of the at least one first cord spool.

12. Operating device according to claim 9, wherein a second axis of rotation of the second wheel is located out of line of the second longitudinal axis of the at least one second cord spool.

13. Operating device according to claim 1, wherein the operating device comprises a plurality of first cord spools, wherein first longitudinal axes of the cord spools mutually coincide.

14. Operating device according to claim 13, wherein the first cord spools are connected to the same shaft part of the first drive shaft.

15. Operating device according to claim 1, wherein the operating device comprises a plurality of second cord spools, wherein the second longitudinal axes of the cord spools mutually coincide.

16. Operating device according to claim 15, wherein the second cord spools are connected to the same shaft part of the second drive shaft.

17. Operating device according to claim 1, wherein the operating device comprises at least one stabilizing element connected to a first cord spool and a second cord spool for securing the mutual positioning of the first cord spool and the second cord spool.

18. Operating device according to claim 17, wherein at least one stabilizing element is coupled to a head end of the first cord spool and a head end of the second cord spool, and wherein the stabilizing element is provided with at least one passage opening for the passage of the first drive shaft and/or the second drive shaft.

19. Operating device according to claim 1, wherein the operating device comprises an elongated support structure in which the cord spools and at least a part of the drive shafts are accommodated.

20. Operating device according to claim 19, wherein the first operating element and the second operating element are placed on opposite end faces of the elongated support structure.

21. Operating device according to claim 19, wherein the elongated support structure is configured for attachment to the fixed world, in particular a frame or ceiling.

22. Assembly of a pleated blind and an operating device according to claim 1, wherein the at least one first cord spool is connected by means of at least one first cord to a lower beam of the pleated blind, and wherein the at least one second cord spool is connected by means of at least one second cord to an upper beam of the pleated blind.
